(19) United States
(12) Patent Application Publication
(10) Pub. No.: US 2006/0049089 A1
(43) Pub. Date: Mar. 9, 2006

(54) System for water dispenser disinfection by integral heating, corresponding method, device and fountains

(76) Inventors: Eric Dietschi, Chardonne (CH); Alexandre Pereira, Cabazat (FR); Eric Fournier, Broutvernet (FR)

Correspondence Address: Dewitt Ross & Stevens;Intellectual Property Department, Excelsior Financial Centre, Suite 401 8000 Excelsior Drives, Madison, WI, 53717-1914, US

(21) Appl. No.: 10/490,925

(22) PCT Filed: Jul. 12, 2002
(86) PCT No.: PCT/FR02/02469

§ 371 Date: Dec. 20, 2004

(30) Foreign Application Priority Data
Sep. 27, 2001 (FR) 01/12624

(51) Int. Cl. B01D 17/09

(52) U.S. Cl. 210/176

(57) ABSTRACT

The invention relates to a water dispenser 1, for example, but not by way of limitation, of the type comprising a removable carboy 2, mounted on a tapping device (and holder) 3; this carboy supplies water to a tank 4 which is connected to a dispensing faucet 6. An evaporator 5 allows optional cooling of the water upstream of the faucet 6. The invention consists in surrounding a portion (sufficient to obtain the desired effect) of the lateral surface of the tank 4 with a heating device 7, in particular a heating plate that fits against the lateral surface of the tank 4. At regular intervals, the plate 7 heats water in the tank 4 to a temperature and for a period of time sufficient to destroy pathogenic bacteria. This method for disinfection by periodic integral heating of a water circulation and distribution system can be applied to any type of dispenser, of the carboy type, the direct expansion type, or the ice-block type. Disinfection is complete, including microcracks, joints and the like, and destruction or prevention of biofilms.

### TECHNICAL FIELD OF THE INVENTION

The present invention relates to the technical field of the devices known as “water dispensers” and, more particularly, disinfection thereof.

It is known that water dispensers are devices used to dispense hot and cold water as desired, using a carboy which is replaced when empty or when an expiry date is reached, or using drinking water mains.

These dispensers primarily comprise a water supply system, a water distribution and refrigeration/heating system, and various control elements.

### TECHNICAL PROBLEM TO BE SOLVED

The problem to be solved is that of the proliferation of both benign and pathogenic bacteria. Naturally, the most severe problems relate to the proliferation of pathogenic bacteria, such as Pseudomonas, E. Coli, Staphylococcus, etc.

Bacterial contamination may occur at various stages of setting up the dispenser, filling the dispenser with water, or using the dispenser.

With carboy dispensers, the dispenser generally comprises a system for tapping the carboy or bottle, and this can be accidentally contaminated each time that it is used.

The cover of the bottle itself can be contaminated whenever it is handled, including during shipping and storage, or when loading the bottle.

Lastly, water present in, for example, the water distribution system of the dispenser provides an opportunity for a bacterial growth known as a “biofilm,” in particular, when not used for a long period of time, but also when used normally.

### BACKGROUND ART

Devices are known (FR 99 13838) that are intended for daily heating of a portion of a system of pipes adjacent to, or close to, the system for tapping the carboy, particularly by means of electrical resistors, in order to cause a thermal shock at 90 to 93° C., lasting long enough (several minutes) to destroy all pathogenic flora.

With such systems, a notable reduction in the bacterial growth has been seen.

Systems are also known in which disinfection, which is seen as being too difficult, has been abandoned in favor of a warning system which is triggered at the end of a predetermined period of time after tapping the carboy (calculated according to official recommendations). Not only do these systems fail to solve the problem of disinfection, being directed simply at preventing a dangerous threshold of pathogenic proliferation from being reached, but these systems are also limited by the attentiveness of personnel.

Such a warning system is, therefore, only useful as a complement to other measures for dealing with the underlying problem.

The fact that such systems exist and are sold clearly indicates that a solution to the technical problem to be solved (which is to say, actual disinfection of water dispensers) is far from simple, given that, in the majority of the cases, people resort to work-around solutions, such as changing the carboy at intervals judged sufficient to ensure good sanitation. Disposable water distribution kits and removable tanks which are replaced or disinfected approximately four times a year are also known.

The frequency at which these are disinfected cannot be increased due to economic considerations (costs). However, laboratory tests show that, after only two weeks, a large amount of flora is already present. Moreover, contamination by pathogenic bacteria can occur at any time during use of the dispenser.

It will be also noted that such systems, which are in any case ineffective, do not in any way eliminate the danger of pathogenic proliferation; in fact, if the carboy tapping device is contaminated, for example, as the result of improper cleaning, replacing the bottle within the given safety period will be of no use. In fact, the pathogenic flora will remain on the tapping device and the openings of the pipes, and will spread all the more easily, as it will have been thought to have been eliminated.

Furthermore, disinfection systems are known which consist of devices for providing hot water, which are periodically connected to dispensers so as to disinfect the system by flushing with hot water at 90 to 95° C. for a suitable period of time. These devices are very effective, but the effectiveness of the disinfection is naturally dependent on the frequency at which one decides to use them.

Furthermore, removable systems or “kits” are known which provide a bottle holding system which is cleaned or discarded after each use. This system appears to include the disadvantages already described.

This system is only able to treat a limited and highly localized area, which is to say, the water inlet area. Lastly, attempts have been made to employ filters on so-called mains dispensers, but these filters are not actually effective and result in dechlorination of the water, which does not serve the interests of sanitation.

Accordingly, there is a significant and recognized need for an effective system for disinfection of water dispenser type devices, which functions independently of the quality of, and the efforts applied to, maintenance, and independently of the frequency at which maintenance is performed, and which does not depend on the cleanliness of materials (cloths, rags, sponges, etc.) that are used for cleaning, nor on the period of time for which the carboy is mounted or, more generally, on the period of time for which water is present in the pipes, tanks, or similar containers, nor on the frequency of disinfection or the cleanliness of the bottle cover provided, and which is effective for any type of dispenser, of any size, whether for home use or for use in companies or communities, using either a carboy or mains.

### SUMMARY OF THE INVENTION

The invention relates to a device and a method known as “integral thermal disinfection,” characterized in that water contained in a dispenser (of any type, as indicated above) is continually disinfected by heating all (or nearly all, as will be seen hereafter) pipes, tanks, faucets, joints, connections, and other elements of the water supply, distribution and circulation circuit, or system of the dispenser, situated between the carboy tapping device (or the mains water outlet) and the dispensing faucet, at a predetermined temperature for a predetermined period of time, and at a predetermined frequency.

Those skilled in the art will understand “all pipes, tanks, faucets, joints, and other elements” to mean either all of the pipes and other elements, or at least as large a portion as is possible of these pipes and other elements and, if possible, almost all of these, and in any event a portion thereof sufficiently large as to ensure the thermal water disinfection function of the invention. It is, for example, possible to treat a specific portion of this system, and to provide a sufficient treatment time so that the areas that are not treated are nevertheless elevated to the treatment temperature by thermal conduction. It is also possible to vary the treatment temperature and/or the frequency of treatment. Those skilled in the art will be able to modify these parameters, given that bacterial proliferation curves, as well as the optimal conditions for destroying pathogenic bacteria, have been well-known for many decades.

It will be recalled that a water dispenser essentially comprises a water inlet area (in the case of a carboy dispenser, this area principally comprises:
a carboy holder, comprising means for “tapping” the carboy, which is to say vertically positioning the carboy and perforating the cover thereof, and an opening of a pipe; in the case of a mains dispenser, this comprises means for connecting the dispenser to the drinking water mains and, likewise, the opening of the pipe);
a tank or water circulation/distribution pipes extending from the holder to one or more faucets for dispensing water to a user;
refrigeration means which may be provided for at least some of the pipes, in particular, if the dispenser comprises two circuits (one to deliver water at normal or moderate temperatures, and the other to deliver chilled or hot water) which control joints, connections, and other parts corresponding to the two circuits;
a heating device for delivering hot water; and
optionally, other control means.

As has been described, some dispensers also comprise localized heating means or means for connecting with hot water disinfection devices.

### DETAILED DESCRIPTION OF THE INVENTION

The invention thus relates to a device and method for thermal disinfection of drinking water in a water dispenser, which is integrated in the dispenser, and is characterized in that water contained in the supply/distribution circuit or system of a water dispenser (of any type, as indicated above) is continually disinfected by heating the entire system or circuit, and thus the water contained in the pipes (and/or tanks, reservoirs, and other elements of the system or circuit that are in contact with the water) of the dispenser, which are situated between the carboy tapping system (or the mains water outlet) and the dispenser faucet, at a predetermined temperature, for a predetermined period of time, and at a predetermined frequency.

Those skilled in the art will understand that the characteristics of the “method” and the “device” will not be unnecessarily repeated, and that a description (or claim) regarding one will serve as a description (or claim) for the other. Thus, a description and a claim for a method comprising a step X will also serve as a description and claim for a device comprising means to implement the aforementioned step X, when these means are well-known or have been described or claimed in relation to the method.

Thus, the prior art essentially conceived of locally heating the water inlet area or certain limited areas. Periodically disinfecting the entire system by means of flushing with very hot water has also been conceived. But, heating all of the pipes in a dispenser has never been conceived.

The industry in question has either made do with the results obtained, even if these results were only partial, or the industry has believed that success in heating all of the pipes was blocked by too many technical obstacles, and that the risks of failure were too great.

There are, in fact, many technical obstacles, which present as many problems to be solved.

On one hand, the pipes, the receptacle, and any built-in tanks, or the kits described above, as well as the dispensing faucet or faucets, comprise joints, connections, protrusions, nozzles, gaps, and the like, which form as many potential traps where bacteria can adhere and proliferate, and where it is difficult to dislodge or destroy bacteria.

Furthermore, even in the best designed systems, water circulating in the pipes inevitably gives rise to a “biofilm” which forms on walls and consists of colonies of nonpathogenic bacteria. This biofilm appears as a transparent, sticky film which, on the one hand, is unpleasant and, on the other hand, forms an ideal culture medium for pathogenic bacteria. Accordingly, such a biofilm represents a constant source of potential danger and encourages the proliferation of pathogenic bacteria when these are present for a sufficiently long period of time.

None of the former systems is capable of, nor for that matter directed at, destroying this biofilm or preventing formation thereof. Elimination of the biofilm nonetheless represents a key factor in terms of sanitation.

The invention solves all the problems described above, including prevention or destruction of the biofilm (or limiting the formation thereof) and disinfection of all gaps, connections, elbows, etc., including cracks and microcracks which unavoidably occur in metal, even in pipes referred to as “smooth.” Such microscopic cracks constitute so many traps for bacteria and cannot be effectively disinfected with known systems; they are all the more troublesome in that they are invisible to the person assigned to periodic cleaning.

A particular object of the invention is a device and a method for thermal disinfection of water in a water dispenser, which is integrated in the dispenser, characterized in that water contained in a “water dispenser” (of any type, as indicated above) is continuously disinfected by way of heat, which is to say, by heating which is limited in time, but is performed at preprogrammed intervals, which are preferably uniform, by heating metal and/or alloys constituting the pipes of the dispenser, which are situated between the carboy tapping system (or water mains inlet) and the dispensing faucet, and/or directly heating the water contained in the system of pipes, at a predetermined temperature, for a predetermined period of time, and at a predetermined frequency, so that all of these (which is to say, all of these parameters) are adequate to produce the desired thermal disinfection effect.

According to a non-limiting preferred mode of embodiment, heating of the pipes is performed by inserting into the water supply (and distribution) pipes of the circuit, along the entire length thereof, or substantially the entire length thereof, a so-called impedance heating tube, which is to say, a metal tube heated by the Joule effect as the result of the flow of an electrical current, which is capable of bringing the temperature of the water to the desired value under the desired operating conditions, and sufficient to obtain the desired thermal disinfection.

According to a preferred mode of embodiment, the pipes themselves constitute an impedance heating tube of this sort. This solution presents clear advantages in that it decisively and completely eliminates all risk.

A well-known non-limiting example of a power supply for such an impedance heating tube supplies approximately 1000 A at a low voltage of approximately 3 V.

It is also possible to use an impedance heating tube for the pipes and another heating means, such as a sheath containing an electrical resistor, for other elements, such as tanks, faucets, valves, and the like.

According to another non-limiting preferred mode of embodiment, heating of the metal or alloy of the pipes is performed by attaching, along the entire length of the pipe, a heating resistor capable of indirectly bringing the temperature of the water to the desired value under the desired operating conditions and capable of producing the desired thermal disinfection.

Persons skilled in the art will understand “the desired value under the desired operating conditions” and “capable of producing the desired thermal disinfection” to mean that the desired or sufficient value is approximately 90 to 95° C. and that the desired or sufficient conditions are those corresponding to a time period and a treatment frequency sufficient to overcome bacterial proliferation, destroy pathogenic bacteria, and preferably, to prevent the formation of biofilm, while remaining economically viable.

Accordingly, the invention provides self-disinfection by way of periodic integral heating of all of the pipes (and/or tanks, etc.) at a disinfecting temperature. This heating is made possible by the low thermal inertia of the materials used in the design of the system of pipes and tanks, etc., which is of course dependent on these elements consisting of a thermally conducting material, such as kitchen quality stainless steel or similar well-known metals or alloys. The invention allows, for the first time, for production of water that always has a sanitary quality identical to that of the water contained in the carboy when delivered. Supposing a possible scenario in which the water in the carboy was accidentally infected before delivery thereof, the system according to the invention would be able to destroy the pathogenic flora.

In addition, as a result of thermal conduction, the tapping system or water inlet, as well as the faucet or faucets, are also disinfected by the method according to the invention.

The treatment according to the invention can, for example, be performed by raising the temperature to 90 to 95° C. for approximately 10 to 20 minutes, and preferably approximately 10 minutes, every 24 hours, and preferably each night.

Thus, the invention essentially encompasses the following aspects:

A method for thermal disinfection of drinking water in a water dispenser, comprising a water distribution circuit or system comprising a water supply point, a distribution circuit or system including pipes, tanks, faucets, and similar circuits, and a dispensing faucet, characterized in that
water contained in the distribution system or circuit is continually disinfected by heating the entire system or circuit, and thus the water contained in the entire system or circuit in contact with the water,
situated between the water supply point (carboy tapping system or mains water outlet) and the dispensing faucet,
at a predetermined temperature, for a predetermined period of time, and at a predetermined frequency, these being sufficient to achieve the aforementioned disinfection.

A device for thermal disinfection of drinking water in a dispenser, which is integrated in the dispenser, comprising a water distribution circuit or system comprising a water supply point, a distribution circuit or system, including pipes, tanks, faucets, and similar circuits, and a dispensing faucet, characterized by comprising:
means for heating, at a predetermined temperature, for a predetermined period of time, and at a predetermined frequency, these being sufficient to achieve the aforementioned disinfection;
the entire system or circuit, and thus the water contained in the entire system or circuit, which is in contact with the water;
situated between the water supply point (carboy tapping system or mains water outlet) and the dispenser faucet.

Water dispensers characterized by implementing a method according to the invention or comprising a device according to the invention.

Pairs (or combinations) of a water pipe 13 and a thermal disinfection heating device 14 that can be used in a device according to the invention.

Other characteristics and advantages of the invention will be better understood by reading the description which follows, referring to the appended drawings in which:

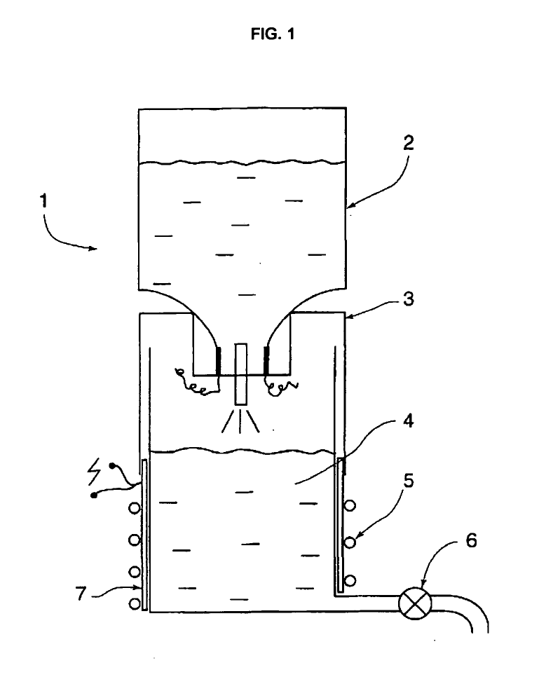

FIG. 1 represents a mode of embodiment of the invention in a so-called carboy-type dispenser;

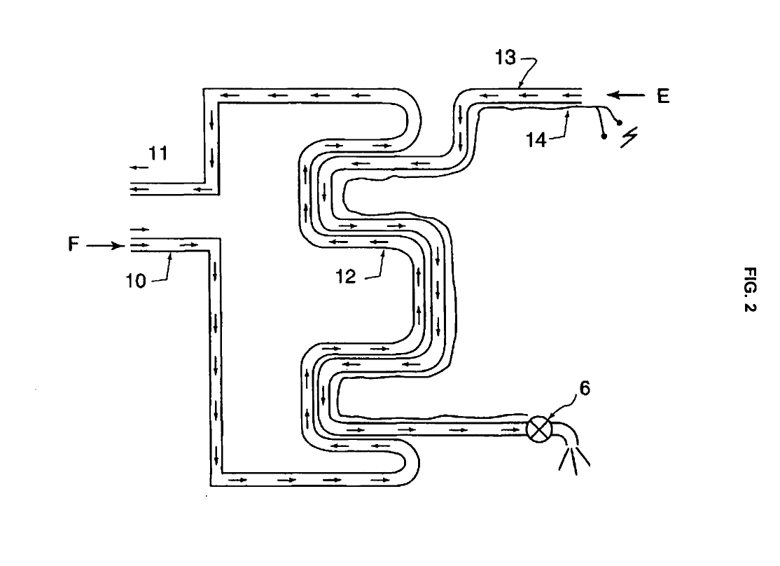

FIG. 2 illustrates a mode of embodiment of the invention in a so-called direct expansion type mains-supplied dispenser;

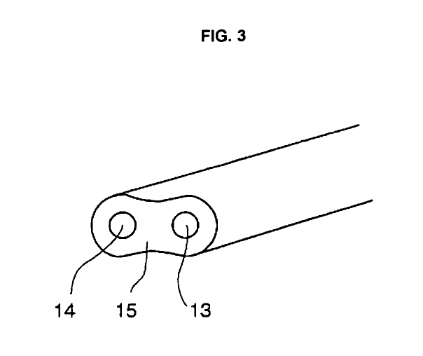

FIG. 3 illustrates a possible mode of embodiment for a combination a of water pipe and an attached heating tube; and

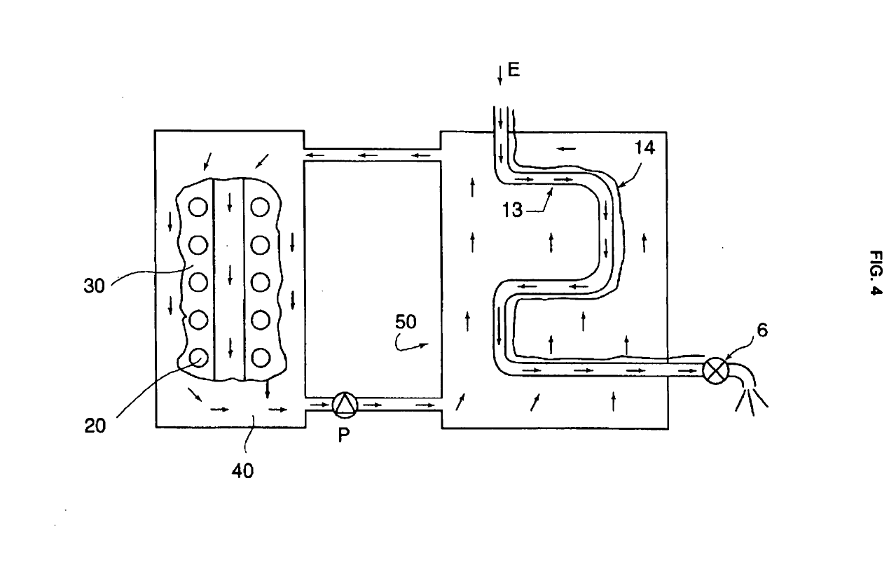

FIG. 4 represents a mode of embodiment of the invention in a so-called ice-block type dispenser.

In the appended figures, identical reference numerals have identical meanings.

The invention will be better understood by reading the description which follows and the non-limiting examples below.

FIG. 1 shows a dispenser 1 of the type having a tank, comprising a removable carboy 2, mounted on a tapping device (and holder) 3; this carboy supplies water to the tank 4 which is connected to a dispensing faucet 6. An evaporator 5 allows optional cooling of the water upstream of the faucet 6. The invention consists in surrounding a portion (sufficient to obtain the desired effect) of the lateral surface of the tank 4 with a heating device 7 and, in particular, with a heating plate that fits against the lateral surface of the tank 4. At regular intervals, the plate 7 heats water in the tank 4 to a temperature, and for a period of time, sufficient to destroy pathogenic bacteria.

A supplementary known heating/disinfection device may be further provided around the carboy tapping device 3.

The heating device 7 can also be provided so as to extend as far as the tapping device 3 so as to disinfect it at the same time as the water contained in the tank 4.

The tapping device 3 may also comprise thermal extensions or connections, made of a heat conducting material, which are immersed in the water of the tank 4; in this manner, the tapping device is also disinfected as the result of heat conducted from the body of water during disinfection of the water in the tank 4. It suffices to heat the water in the tank 4 for a period of time that is sufficient to establish thermal conduction and allow for effective disinfection of the tapping device.

It is conceived that, if necessary, the tank 4 can be replaced by a coiled pipe to which a disinfection heater and an optional cooling element can be attached. A system of this type is illustrated in FIG. 2.

FIG. 2 illustrates a so-called direct-expansion type water dispenser, which is supplied from drinking water mains. The drinking water E enters and circulates in pipes 13, which are generally wound into a coil. Cooling fluid F enters at 10 and circulates in a pipe affixed to the pipe 13 in order to produce cold water. A heating device 14 for disinfection according to the invention is attached to the water pipe 13. It is especially preferred that this device 14 be attached to the water pipe along the entire length thereof and up to the faucet 6, as is shown. However, according to a variant, the disinfection heating device 14 can disinfect both ends by thermal convection alone.

FIG. 3 illustrates a non-limiting mode of embodiment of a pair comprising the water pipe 13 and the disinfection heating device 14 according to the invention. It can be seen that the water pipe 13 and the disinfection heating device 14 are thermally united in a heat conducting sheath 15. The sheath 15 is shaped so as to accommodate the cooling tube 12 against a wall that is proximal to the water pipe 13.

FIG. 4 illustrates an implementation of the invention in a dispenser of the type having an ice block. In this type of dispenser, the refrigeration of the water is achieved by way of a secondary cooling circuit 40, equipped with an evaporator 20, which forms a block of ice 30 around the exchanger tubes thereof. The cooling fluid is moved by a pump P in the direction of an enclosure 50 where a drinking water pipe 13 is attached to a disinfection device 14 according to the invention, for example, a device having a sheath, as shown in FIG. 3. The drinking water E enters, either from the mains or from a carboy, and is dispensed by a faucet 6.

Those skilled in the art will readily understand that the materials will be suited both to ensuring good thermal conductivity and to withstanding the disinfection temperature.

As a precaution, an indicator lamp and, optionally, an audible alarm, such as a vibrator or buzzer, can be activated when the disinfection device operates in order to avoid any risks of burns, either by the water or by a part of the dispenser. Such a warning system can, for example, be triggered by programmed startup of the disinfection device according to the invention and can be disconnected when the temperature has returned to a safe level. It can also be triggered and stopped by a thermostat.

The system of the invention is preferably programmed with a memory and a clock, as well as any suitable electrical or mechanical means. As mentioned above, the device is programmed to begin operations when not in use, particularly at night.

All of these systems have been known for decades in many industries and, in particular, in the electrical household appliance industry, and will not be described herein.

The invention also encompasses all modes of embodiment and applications which are directly accessible to those skilled in the art from perusal of the present application, from their own knowledge, and optionally, from simple routine tests.

1. A method for thermal disinfection of drinking water in a water dispenser, comprising a water distribution circuit or system, comprising a water supply point, a distribution circuit or system, including pipes, tanks, faucets, and similar circuits, and a dispensing faucet, characterized in that:
water contained in the distribution system or circuit of said dispenser is continually disinfected by heating the entire system or circuit, and thus the water contained in the entire system or circuit, which is in contact with the water, situated between the water supply point (carboy tapping system or mains water outlet) and the dispensing faucet, the heating being performed at a predetermined temperature, for a predetermined period of time, and at a predetermined frequency, which are sufficient to achieve said disinfection.

2. A method according to claim 1 characterized in that heating of the pipes is performed by inserting into the water supply (and distribution) pipes of said circuit, along the entire length thereof, or substantially the entire length thereof, a so-called impedance heating tube, which is to say, a metal tube heated by the Joule effect as the result of a flow of electrical current, which is capable of bringing the temperature of the water to the desired value under the desired operating conditions, the pipes themselves preferably constituting an impedance heating tube of this sort, and optionally in that an impedance heating tube is used for the pipes, and another heating means, such as a sheath containing an electrical resistor, is used for other elements, such as tanks, faucets, valves, and the like.

3. A method according to claim 1 or 2, characterized in that a power supply for such an impedance heating tube is approximately 1000 A at a low voltage of approximately 3 V.

4. A method according to claim 1 or 2 characterized in that, heating of the metal or alloy of the pipes is performed by attaching to the pipe, along the entire length thereof, a heating resistor capable of indirectly bringing the temperature of the water to the desired value under the desired operating conditions.

5. A method according to any one of claims 2 to 4, characterized in that said desired value is approximately 90 to 95° C. and said desired conditions are those corresponding to a time period and a treatment frequency sufficient both to overcome bacterial proliferation and to destroy pathogenic bacteria.

6. A method according to claim 5 characterized in that said value and said conditions are adequate to prevent the formation of, or to destroy, a biofilm.

7. A method according to any one of claims 2 to 5, characterized in that in that, not only the pipes, but also other elements of said water distribution circuit, such as tanks, faucets, joints, and connections, are treated.

8. A device for thermal disinfection of drinking water in a water dispenser, which is integrated in said dispenser, comprising a water distribution circuit or system, comprising a water supply point, a distribution circuit or system, including pipes, tanks, faucets, and similar circuits, and a dispensing faucet, characterized
by comprising means for heating, at a predetermined temperature, for a predetermined period of time, and at a predetermined frequency, which are sufficient to achieve the aforementioned disinfection,
the entirety of said system or circuit, and thus the water contained in the entire system or circuit, which is in contact with the water,
situated between the water supply point (carboy tapping system or mains water outlet) and the dispensing faucet.

9. A device according to claim 8 characterized by comprising means for heating pipes by inserting into the water supply (and distribution) pipes of said circuit, along the entire length thereof, or substantially the entire length thereof, a so-called impedance heating tube, which is to say, a metal tube heated by the Joule effect as the result of a flow of electrical current, which is capable of bringing the temperature of the water to the desired value under the desired operating conditions, and sufficient to obtain the desired disinfection.

10. The method according to claim 8 or 9, characterized in that a power supply for such an impedance heating tube is approximately 1000 A at a low voltage of approximately 3 V.

11. A method according to claim 8 or 9 characterized by comprising means for heating the metal or alloy of the pipes by attaching to the pipe, along the entire length thereof, a heating resistor capable of indirectly bringing the temperature of the water to the desired value under the desired operating conditions, and sufficient to obtain the desired disinfection.

12. A method according to any one of claims 8 to 11, characterized in that said desired value is approximately 90 to 95° C. and said desired conditions are those corresponding to a time period and a treatment frequency sufficient both to overcome bacterial proliferation and to destroy pathogenic bacteria.

13. A device according to claim 12 characterized in that said value and said conditions are adequate to prevent the formation of a biofilm.

14. A method according to any one of claims 8 to 13, characterized by comprising means for heating, not only the pipes, but also other elements of said water distribution circuit, such as tanks and faucets.

15. Devices according to any one of claims 8 to 14, characterized in that the entirety of said water distribution system, pipes, tanks, faucets and bottle tapping device is composed of a material having a low thermal inertia, a thermal conductor, such as kitchen quality stainless steel, or similar metals or alloys.

16. Devices according to any one of claims 8 to 15, characterized by comprising a combination of water pipes and an attached heating tube.

17. Devices according to any one of claims 8 to 16, characterized by comprising means for performing said treatment by raising the temperature to 90 to 95° C. for approximately 10 to 20 minutes, and preferably approximately 10 minutes each night.

18. Water dispensers characterized by implementing a method according to any one of claims 1 to 7, or comprising a device according to any one of claims 8 to 17.

19. Water dispensers according to claim 18 characterized by being:
so-called carboy-type dispensers;
so-called direct expansion type mains-supplied dispensers; or
so-called ice-block type dispensers.

20. A water dispenser according to claim 18 or 19 comprising: a water dispenser (1) of the type having a tank or a carboy, comprising a removable carboy (2), mounted on a tapping device (and holder) (3), which supplies water to a tank (4), which is connected to a dispensing faucet (6); and an evaporator (5) allowing optional cooling of the water upstream of the faucet (6), characterized in that a portion (sufficient to obtain the desired thermal disinfection effect) of the lateral surface of the tank (4) is surrounded by a heating device (7), in particular a heating plate that fits against the lateral surface of the tank (4), and comprises control means whereby, at regular intervals, the plate (7) heats the water in the tank (4) to a temperature, and for a period of time, sufficient to destroy pathogenic bacteria, and particularly to 90 to 95° C. for 10 to 20 minutes in each 24 hour period.

21. A dispenser according to claim 20 characterized in that a supplementary heating/disinfection device is further provided around the carboy tapping device (3).

22. A dispenser according to claim 20 or 21, characterized in that the heating device (7) extends as far as the tapping device (3) so as to disinfect it at the same time as the water contained in the tank (4).

23. A dispenser according to any one of claims 20 to 22, characterized in that the tapping device (3) comprises thermal extensions or connections, made of a heat conducting material, which are immersed in the water in the tank (4) so that the tapping device is also disinfected as the result of a thermal conduction effect from the body of water during disinfection of the water in the tank (4).

24. A dispenser according to any one of claims 20 to 23, characterized in that the tank (4) is replaced by a coiled pipe, to which a disinfection heating element, and optionally a cooling element, are attached.

25. A water dispenser according to claim 18 or 19, being a so-called direct-expansion type dispenser of the type supplied by drinking water mains, drinking water (E) entering and circulating in pipes (13), which are generally wound into a coil, and cooling fluid (F) entering (10) and circulating in a pipe attached to the pipe (13), in order to produce cold water, characterized by comprising a thermal disinfection heating device (14) attached to the water pipe (13), said device (14) being attached to the water pipe along the entire length thereof, as far as the faucet (6).

26. A pair comprising the water pipe (13) and the disinfection heating device (14) that can be used in devices according to claim 16, characterized by comprising the water pipe (13) and the disinfection heating device (14) that are thermally united in a heat conducting sheath (15), shaped so as to accommodate the cooling tube (12) against a wall that is proximal to the water pipe (13).

27. A so-called ice-block type dispenser according to claim 18 or 19, the refrigeration of the water being achieved by way of a secondary cooling circuit (40), powered by an evaporator (20), which forms a block of ice (30) around the exchanger tubes thereof, the cooling fluid being moved by a pump (P) in the direction of an enclosure (50) where a drinking water pipe (13) is located, characterized in that said pipe (13) is attached to a thermal disinfection device (14).

28. A dispenser according to claim 27, characterized in that said disinfection device forms a pair according to claim 26.

29. A dispenser according to any one of claims 20 to 27 characterized in that an indicator lamp, and optionally an audible alarm, such as a vibrator or buzzer, is activated when the disinfection device operates, in order to avoid any risks of burns, either by the water or by a part of the dispenser.

30. A dispenser according to any one of claims 20 to 29, characterized in that the thermal disinfection method and device and said alarm system are programmed with a memory and a clock, and electrical or mechanical means, capable of starting up at a given time and with a given frequency, and of regulating the temperature at a given value for a given period of time.
